(19) United States
(12) Patent Application Publication
(10) Pub. No.: US 2009/0081987 A1
(43) Pub. Date: Mar. 26, 2009

(54) METHOD OF EARNING CELL PHONE USAGE BY ENGAGING IN EDUCATIONAL ENDEAVORS

(76) Inventor: ERNEST W. MOODY, LAS VEGAS, NV (US)

Correspondence Address: JOHN EDWARD ROETHEL, 769 Basque Way, Suite 200, Carson City, NV, 89706, US

(21) Appl. No.: 11/860,024

(22) Filed: Sep. 24, 2007

(51) Int. Cl. H04M 15/18

(52) U.S. Cl. 455/405

(57) ABSTRACT

A method of earning cell phone usage in the form of either talk time or text messages by engaging in educational endeavors. In order to receive the cell phone usage, the customer must correctly answer questions or complete educational assignments posed to the user through the cell phone or online using a computer. Cell phone usage is earned for correctly answering the questions showing that the educational endeavor has been successfully completed. Failure to answer the questions correctly or to successfully complete the assignments can result in the customer's cell phone usage being curtailed or even cancelled or terminated.

This invention relates to a method of earning cell phone usage, and more particularly to a method of earning cell phone usage by engaging in educational endeavors.

### BACKGROUND OF THE INVENTION

Mobile telephones or cell phones have proliferated in the last ten years. Typically, a customer contracts with a cell phone provider to obtain cell phone talk time which is generally paid for by the minute of cell phone usage. A customer can purchase a monthly block of cell phone talk time for a fixed amount of money and any excess used over the monthly block of talk time is charged by the minute.

One way of ensuring that large cell phone bills are not incurred is to require customers to prepay for a set amount of minutes each month. Once the set amount of minutes has been used, the cell phone becomes inactive until additional phone time is purchased.

Many parents desire that their children carry cell phones so that the parents may be able to stay in contact with their children. However, children are not particularly careful about the amount of cell phone minutes that they use which results in their parents having to pay high cell phones bills for the convenience and safety of having phone access to their children. Cell phone providers have addressed this problem in at least one way by providing cell phones that restrict the phone numbers that can be dialed or received by the child's cell phone.

Cell phone customers, especially children and students, also like the convenience of cell phones as a way of keeping in contact with their friends, either by voice calls or by text messaging. Most customers would enjoy a method in which they could obtain additional cell phone talk time or additional text messages without having to expend money, which is typically in short supply for the average child or student.

In an article dated May 30, 2006, the New York Times (http://www.nytimes.com/2006/05/30/business/media/30virgin.html?ex=1306641600&en=d77ae505e7ef6eb6&ei=5088 reported on a plan promoted by Virgin Mobile USA by which cell phone customers could earn cell phone calling time by receiving advertisements.

“The program, called SugarMama, lets people earn one minute of talking time by watching 30-second commercials on a computer or receiving text messages on their phones, then answering questions to prove they were, in fact, paying attention. Virgin Mobile, a relatively small cellphone carrier with four million mostly young customers, is aiming the program at teenagers, who can earn up to 75 minutes of free talk time a month.”

In an article dated Feb. 18, 2005, (http://www.businessweek.com/technology/content/feb2005/tc2005 0218_{—}4609_tc024.htm) Business Week reported that Mattel would soon start selling a cell phone to the pre-teen market that would include cell phone minutes as a parenting tool.

“Mattel and Single Touch are also positioning the cell phone as a parenting tool. Moms and dads will be able to buy those additional minutes for their kids online. When parents activate the new phone, they can go to a Web site, MySceneMobile.com, and list chores they want their children to perform to earn extra minutes. These can include making the bed, doing homework, or not fighting with brothers and sisters. At the end of each month, parents can buy extra minutes if their children have, indeed, behaved.”

Text messaging by cell phone has also become quite popular and, in many younger demographic segments of the population, threatens to become the dominant form of instantaneous communication. A text messaging customer uses the cell phone keypad to compose a text message and then transmits that text message to the intended recipients using the same wireless technology that empowers the cell phone. Cell phone providers charge “per text message” rather than “per minute” for the text messaging service. The customer can buy a package plan from the cell phone provider that covers a fixed number of text messages per month with any overage being charged on a per message basis. As with cell phone monthly talk time minutes, text message customers (particularly younger users) tend to exceed their monthly package of text messages and thus incur additional expense.

There is a need in the cell phone business to provide a method of earning additional cell phone talk time or text messages by having customers, especially children and students, engage in educational endeavors. In order to ensure that the educational endeavors have actually been carried out, the customer who wishes to earn extra cell phone talk time or text messages can be required to interact with the educational center, such as a school or other educational institution or sponsor, to participate in the educational endeavor. This communication can be effected either by using the cell phone itself or by a computer connected online to the educational center.

### SUMMARY OF THE INVENTION

The present invention provides a method of earning cell phone usage in the form of either talk time or text messages by engaging in educational endeavors. In order to receive the cell phone usage, the customer must correctly answer questions or complete educational assignments posed to the user through the cell phone or online using a computer. Cell phone usage is earned for correctly answering the questions showing that the educational endeavor has been successfully completed. Failure to answer the questions correctly or to successfully complete the assignments can result in the customer's cell phone usage being curtailed or even cancelled or terminated.

### DETAILED DESCRIPTION OF THE PREFERRED EMBODIMENTS

A method of earning cell usage is effected by engaging in educational endeavors. As used in this specification and the accompanying claims, cell phone usage is intended to include both talk time and text messages. Typically, cell phones usage is measured by the minutes that the cell phone is used to make or receive phone calls. Cell phone minutes can be costly and it would be desirable for most customers, especially children and students, to have a method of obtaining cell phone minutes without actually having to spend money for such minutes.

Likewise text messaging is typically measured and paid for by the number of text messages sent or received by the customer. When a customer exceeds his monthly text messaging plan numbers, additional expense is incurred and it would also be desirable for most customers, especially children and students, to have a method of obtaining the ability to transmit or receive additional text messages without actually having to spend money for such text messages.

The method of the present invention allows a customer, especially children and students, to earn cell phone usage by answering educational questions or completing educational assignments.

For elementary age children, the educational questions and assignments could be spelling or math related. Other subjects could include reading, grammar, geography or history. For middle school and high school students, additional subjects could be included such as chemistry, physics, civics and the like. The method of the present invention could also be applied to college level or continuing educational courses. Any school, educational institution or even businesses, non-profit groups or governmental entities that have a need to educate or instruct children, students, employees or other participants could reward successful participation by providing cell phone time or text messages to its users.

In an example of how the method of the present invention would work, the student or his parents would register the student for the cell phone usage program. Preferably, the parents would pay for the cell phone usage that the student could earn, although other methods of paying for the cell phone usage could be utilized, such as advertiser support or non-profit organizational support.

When the student is registered, a demographic selection could be provided so that the parents can designate the school subjects for which the student would be eligible to earn cell phone usage.

The student would phone in to an educational center and select the school topic that the child would like to answer questions concerning. The educational center would transmit questions to the user to be answered. Questions could be in a true/false format or in a multiple choice format which the student would answer by pressing the appropriate button on the cell phone key pad and transmitting the answer back to the educational center. Alternatively, the student could be required to answer the question by text messaging words back to the educational center.

Correct answers would be rewarded with cell phone usage. The more difficult the question, the more cell phone usage could be earned for correct answers. The educational center could provide a web site at which the parents could oversee the student's progress in learning the school material or the educational center could report periodically by paper mail or other communication means with the parents to report on the use of the program by the student.

Alternatively, the student could communicate with the educational center by using a computer. This would allow educational assignments to completed online, such as actually interactively taking classes and writing reports or engaging in laboratory work. Tests could also be taken online.

One benefit of the present invention is that the failure to participate in the educational endeavors can result in the customer losing his cell phone usage or having it seriously curtailed. For example, whenever a student fails an exam, or fails to submit his assignments or even fails to participate in the class work, the student's cell phone can be turned off. This can be effected directly by the educational center when certain threshold levels of failure or non-participation have been achieved. Or this can be effected indirectly by having the educational center contact the student's parents who would then effect the cancellation or termination of the student's cell phone. Alternatively, the student could simply lose cell phone usage for failure to comply with the program requirements.

Likewise, the method of the present invention can be expanded beyond mere student participation as discussed above. By providing similar interaction by cell phone or online computer, a business, non-profit organization or governmental entity can encourage customer or employee participation by awarding cell phone time or text messages for the successful completion of educational endeavors.

While the invention has been illustrated with respect to several specific embodiments thereof, these embodiments should be considered as illustrative rather than limiting. Various modifications and additions may be made and will be apparent to those skilled in the art.

What is claimed is:

1. A method by which a cell phone user can earn cell phone usage comprising:
a) registering to participate in a cell phone usage program; and
b) successfully completing an educational endeavor whereby the customer earns cell phone usage.

2. The method of claim 1 in which the educational endeavor comprises correctly answering questions.

3. The method of claim 1 in which the educational endeavor comprises successfully passing an exam.

4. The method of claim 1 in which the educational endeavor comprises successfully completing an assignment.

5. A method by which a cell phone user controls his cell phone usage comprising:
a) registering to participate in a cell phone usage program; and
b) participating in the cell phone usage program whereby:
1) if the cell phone user successfully participates in the cell phone usage program, the cell phone user earns cell phone usage;
2) if the cell phone user unsuccessfully participates in the cell phone usage program, the cell phone user loses cell phone usage.

6. The method of claim 5 in which the cell phone usage program is an educational endeavor.

7. The method of claim 6 in which the educational endeavor comprises answering questions and correct answers earn cell phone usage and incorrect answer lose cell phone usage.

8. The method of claim 6 in which the educational endeavor comprises taking an exam and passing the exam earns cell phone usage and failing the exam loses cell phone usage.

9. The method of claim 6 in which the educational endeavor comprises performing an assignment and successfully completing the assignment earns cell phone usage and unsuccessfully completing the assignment loses cell phone usage.
